(19) United States
(12) Patent Application Publication
(10) Pub. No.: US 2025/0126420 A1
(43) Pub. Date: Apr. 17, 2025

(54) REMOVABLE POWER SOURCE MODULE FOR CUSTOM HEARING INSTRUMENTS

(71) Applicant: Starkey Laboratories, Inc., Eden Prairie, MN (US)

(72) Inventors: Joseph Matthias Reis, JR., Minneapolis, MN (US); Ganesh Borra, Plymouth, MN (US)

(21) Appl. No.: 18/893,595

(22) Filed: Sep. 23, 2024

Related U.S. Application Data
(60) Provisional application No. 63/589,810, filed on Oct. 12, 2023.

(51) Int. Cl. H04R 25/00; H04R 1/10

(52) U.S. Cl. CPC H04R 25/602; H04R 1/1058; H04R 25/554; H04R 25/609; H04R 25/652; H04R 25/658; H04R 2225/31; H04R 2225/57; H04R 2420/07

(57) ABSTRACT

A hearing instrument configured to be worn in, on, or about an ear of a user, the hearing instrument comprising: a shell defining an inner recess; processing circuitry disposed within the inner recess, the processing circuitry being configured to cause the hearing instrument to output sound; a faceplate coupled to the shell, the faceplate being configured to enclose the inner recess from an external environment; and a removable power source module configured to be disposed within the inner recess, the removable power source module comprising a power source, wherein the removable power source module is removably affixed to the faceplate.

This application claims the benefit of U.S. provisional patent application 63/589,810, filed Oct. 12, 2023, and entitled “Removable Power Source Module for Custom Hearing Instruments”, the entire content of which is incorporated by reference.

### TECHNICAL FIELD

This disclosure relates to hearing instruments, and more specifically, hearing instruments that are powered by a removable power source.

### BACKGROUND

Hearing instruments are devices designed to be worn on, in, or near one or more of a user's ears. Common types of hearing instruments include hearing assistance devices (e.g., “hearing aids”), earbuds, headphones, hearables, cochlear implants, and other devices designed for placement inside or in close proximity to an ear canal of a wearer. Some hearing instruments include additional features beyond just environmental sound-amplification. For example, some modern hearing instruments include advanced audio processing for improved device functionality, controlling and programming the devices, and beamforming, and some can even communicate wirelessly with external devices.

Some hearing instruments are customized, e.g., formed to conform with user anatomy. For example, hearing instruments can be formed by scanning the shape of an ear canal of a user (i.e., a patient), and then forming or printing a hearing instrument housing to have a shape that precisely conforms to the ear of the user.

Hearing instruments generally have limited space for various circuit components within the housing. Layout and arrangement of the components within hearing instruments may improve operational performance and user satisfaction.

### SUMMARY

This disclosure describes various mechanical designs and features for hearing instruments. The hearing instrument may include a shell and a faceplate defining an outer surface of the hearing instrument. The shape of the shell may be customized to a user, e.g., to the shape of the ear canal of the user. The hearing instrument may include a removable power source module configured to be disposed within an inner recess defined by the shell and the faceplate and provide power to components of the hearing instrument housed within the inner recess. The removable power source module may include a power source, a cap, and electrical contact(s) electrically coupled to the power source. When the removable power source module is disposed within the hearing instrument, the power source may be electrically coupled to circuitry of the hearing instrument via the electrical contact(s). The power source of the power source module may then supply electrical power to circuitry of the hearing instrument via the electrical contact(s). The removable power source module may be affixed to the faceplate and may be removed from the hearing instrument by detaching the power source module from the faceplate. For example, the cap of the removable power source module may be removably affixed to the faceplate, e.g., to secure the removable power source module within the hearing instrument.

The example devices, systems, and methods described herein may provide several advantages over other hearing instruments. Fixation of the power source module to the faceplate may allow for removal of the power source module from the hearing instrument without requiring separation of the faceplate from the shell. The capability of removing the power source module without separating the faceplate from the shell may allow for simple replacement of the power source module in the hearing instrument by a clinician and/or the user, e.g., without requiring disassembly of the hearing instrument. The removable power source module may also provide improved sealing of the power source compared to hearing instruments with a removable power source, e.g., a removable battery. The removable power source module may also allow for simple replacement of power regulation circuitry connecting the power source to circuitry of the hearing instrument without requiring disassembly of the hearing instrument, which may simplify replacement of defective power regulation circuitry in the field.

In some examples, the disclosure describes a hearing instrument configured to be worn in, on, or about an ear of a user, the hearing instrument comprising: a shell defining an inner recess; processing circuitry disposed within the inner recess, the processing circuitry being configured to cause the hearing instrument to output sound; a faceplate coupled to the shell, the faceplate being configured to enclose the inner recess from an external environment; and a removable power source module configured to be disposed within the inner recess, the removable power source module comprising a power source, wherein the removable power source module is removably affixed to the faceplate.

In some examples, the disclosure describes a power source module comprising: a power source; a plurality of electrical contacts electrically coupled to the power source; and a cap connected to the power source, wherein the power source module is configured to be disposed within a hearing instrument configured to be worn in, on, or about an ear of a user; and wherein the power source module is configured to be removed from within the hearing instrument without requiring disassembly of the hearing instrument.

In some examples, the disclosure describes a method of manufacturing a hearing instrument configured to be worn in, on, or about an ear of a user, the method comprising: forming, by a manufacturing system, a shell of the hearing instrument, wherein the shell is configured to conform to a shape of an ear canal of the user; disposing, by the manufacturing system, processing circuitry of the hearing instrument within an inner recess defined by the shell; disposing, by the manufacturing system, a faceplate over the shell to enclose the inner recess; and inserting, by the manufacturing system, a removable power source module into the inner recess of the hearing instrument via a channel in the faceplate, wherein the removable power source module comprises a power source and a cap.

The details of one or more techniques of the disclosure are set forth in the accompanying drawings and the description below. Other features, objects, and advantages of the techniques described in this disclosure will be apparent from the description, drawings, and claims.

### BRIEF DESCRIPTION OF DRAWINGS

FIG. 1 is a conceptual diagram illustrating an example hearing instrument and manufacturing system.

FIG. 2 is a conceptual diagram illustrating a front view of the example hearing instrument of FIG. 1.

FIG. 3 is a block diagram illustrating example components of the example hearing instrument of FIG. 1.

FIG. 4 is a cross-sectional diagram illustrating a cross-sectional view of the example hearing instrument of FIG. 1, the cross-section being taken along line A-A of FIG. 2.

FIG. 5 is a cross-sectional diagram illustrating a cross-sectional view illustrated in FIG. 4 with the removable power source module removed from the hearing instrument.

FIG. 6 is a cross-sectional diagram illustrating a cross-sectional view of the example hearing instrument of FIG. 1 with a gasket, the cross-section being taken along line A-A of FIG. 2.

FIG. 7 is a conceptual diagram illustrating an example power source module of the hearing instrument of FIG. 6.

FIG. 8 is a conceptual diagram illustrating an example of the hearing instrument of FIG. 1 with a cross pin.

FIG. 9 is a conceptual diagram illustrating an example of the hearing instrument of FIG. 1 with an antenna.

FIG. 10 is a conceptual diagram illustrating a front view of an example of the hearing instrument of FIG. 1 with another example antenna.

FIG. 11 is a flow chart illustrating an example process of manufacturing an example hearing instrument.

FIG. 12 is a flow chart illustrating an example process of replacing an example removable power source module within an example hearing instrument.

### DETAILED DESCRIPTION

Wireless communication links are becoming increasingly desirable for hearing instruments, such as hearing aids. A hearing instrument may use wireless communication links to communicate with other hearing instruments or with other types of devices, such as mobile phones or hearing instrument accessories. Such communication may serve a wide variety of purposes, such as streaming media data and sending sensor data. Hearing instruments may be worn on, about, or around ears of the user. Hearing instrument may include, but are not limited to, completely-in-canal (CIC) hearing instruments In-The-Ear (ITE) hearing instruments, In-The-Canal (ITC) hearing instruments, or Invisible-In-The-Canal (IITC) hearing instrument.

A hearing instrument may be completely encapsulated by a shell and a faceplate of the hearing instrument. When the shell is attached to the faceplate, the shell and the faceplate may seal an inner recess of the hearing instrument against an external environment. Circuitry and components of the hearing instrument may be disposed within the inner recess of the hearing instrument. The shape of the shell may be customized to the user. For example, the shape of the shell may be molded to conform to the shape of the car canal of the user. The customized shape of the shell may increase user comfort and/or retention of the hearing instrument within the car of the user.

Circuitry and components of the hearing instrument may be powered by a power source disposed within the inner recess. Power sources may include, but are not limited to, batteries, supercapacitors, or the like. In some examples, power sources may be permanently disposed within the hearing instrument and/or may be affixed to the faceplate and/or shell of the hearing instrument. In such examples, power sources may not be capable of being removed by the user and/or a clinician and may require disassembly of the hearing instrument, e.g., by the manufacturer, to be accessed. The power source may be electrically coupled to the circuitry and components of the hearing instrument via power management circuitry, which may monitor and manage power levels within the power source. In some hearing instruments, the power management circuitry is disposed within the inner recess of the hearing instrument and access to the power management circuitry requires disassembly of the hearing instrument. Thus, access to and/or replacement of power sources and/or power management circuitry may require disassembly of the hearing instrument, which may lead to unintended alterations of the hearing instrument and/or render access to or replacement of power sources and/or power management circuitry infeasible to perform in the field (e.g., by the user or the clinician).

This disclosure describes several features to facilitate replacement power sources within customized hearing instruments. For example, the power source and the power management circuitry may be disposed within a standardized removable power source module. The removable power source module may be affixed to the faceplate of the hearing instrument. Such features may allow a user or a clinician to simply and quickly replace used and/or defective power sources and/or power management circuitry, e.g., without requiring disassembly of the hearing instrument. The removable power source assemblies described herein may also provide for improved sealing of the power source against an external environment and may facilitate improved electrical connections between the power source and the circuitry and components of the hearing instrument. For example, the battery door may be designed and positioned in a specific location that still allows for battery cycling (e.g., removal and replacement) while the hearing instrument is being worn and used. Several other features are also described, which help facilitate the desired location of the antenna and the battery and may provide additional benefits to the packaging of components within the hearing instrument.

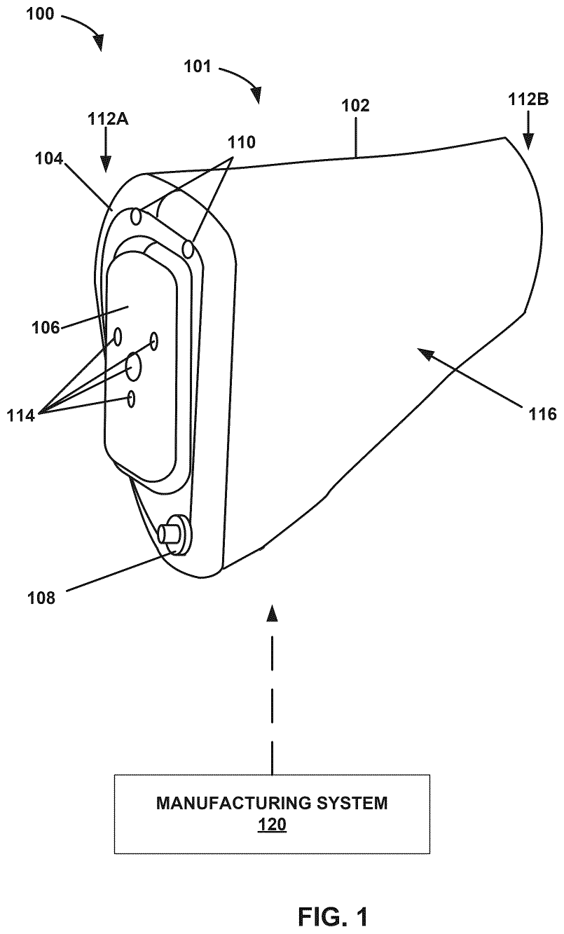

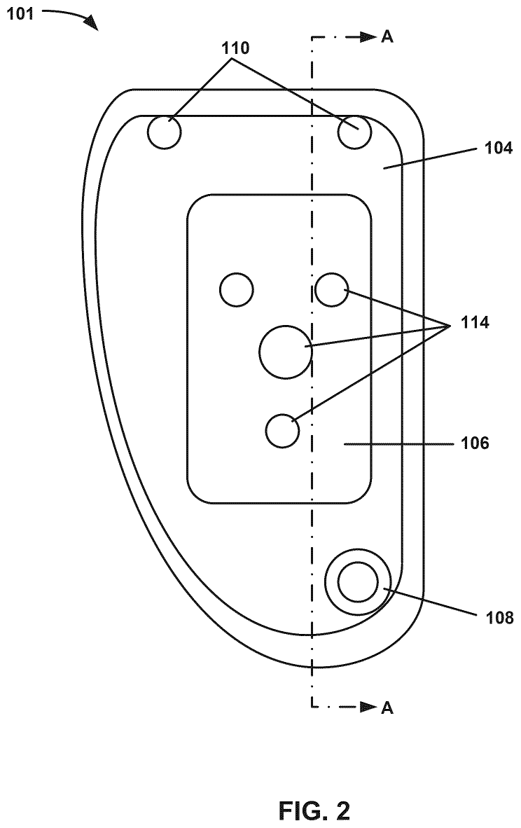

FIG. 1 is a conceptual diagram illustrating an example hearing instrument system 100. FIG. 2 is a conceptual diagram illustrating a front view of the example hearing instrument 101 of FIG. 1. Hearing instrument system 100 (also referred to herein as “system 100”) may include hearing instrument 101 and a removable power source module. Hearing instrument 101 may extend from a first end 112A to a second end 112B. Hearing instrument 101 may include a shell 102, a faceplate 104 secured to shell 102, and a removable power source module disposed within an inner recess defined by shell 102 and faceplate 104. The removable power source module may be secured to faceplate 104 via a cap 106.

Shell 102 may extend from first end 112A to second end 112B. When hearing instrument 101 is disposed within the car canal of the user, first end 112A may extend towards an external environment outside of the car canal and second end 112B may extend towards the car drum of the user. Shell 102 may define an outer surface 116. Outer surface 116 may be in apposition with the surface of the car canal of the user when hearing instrument 101 is disposed within the car canal. The shape of shell 102 may be customized to the shape of the car canal of the user. The customized shape of shell 102 may reduce patient discomfort and increase retention of hearing instrument 101 within the car, e.g., in response to movement of the head of the user. The shape of shell 102 may define both the shape of outer surface 116 and shape of an inner recess of shell 102. Shell 102 may define an open end at first end 112A and a closed end at second end 112B. In some examples, shell 102 define open ends at both ends 112A, 112B. Shell 102 may be formed using injection molding, cutting and buffing, or three-dimensional (3D) printing, based on a scan or mold of the car canal of the user such that hearing instrument 101 only fits inside the car of the user in a specific orientation.

Faceplate 104 may be coupled to shell 102 at first end 112A, e.g., to seal the open end at first end 112A. Faceplate 104 may be shaped to conform to the customized shape (e.g., the customized perimeter) of shell 102. Faceplate 104 may include one or more external features disposed on or extending through faceplate 104 into the inner recess. The one or more external features may include, but are not limited to, input element(s) 110, user interface (UI) control(s) 108, or one or more antennas. Faceplate 104 may define a channel (not picture) sized to facilitate travel of a removable power source module into and out of the inner recess defined by shell 102 and faceplate 104. When the removable power source module is disposed within the inner recess, cap 106 of the power source module may be affixed to faceplate 104.

Cap 106 is attached to the removable power source module. When the power source module is disposed within the inner recess, cap 106 may interface with faceplate 104 to seal the inner recess from an external environment. Cap 106 may interface with faceplate 104 via one or more fixation features including, but are not limited to, a gasket, a cross pin, a snap fit feature, a screw, a locking lug, or the like. The removable power source module may only be attached to hearing instrument 101 via cap 106. For example, the removable power source module may not contact or otherwise interface with shell 102 and/or circuits and components within the inner recess.

Cap 106 may include one or more contact(s) 114 disposed on an external surface. Contact(s) 114 may be electrically connected to the power source within the power source module, e.g., via one or more electrical conductors within the assembly. Contact(s) 114 may be electrically coupled to an external power source via a charging element and may transmit electrical power between the power source within the power source module and the external power source, e.g., to recharge or discharge the power source within the power source module.

Input element(s) 110 may be configured to receive input audio. In some examples, input element(s) 110 include one or more microphones configured to receive input audio and convert the input audio into an electrical signal. In some examples, input element(s) 110 include one or more input ports configured to couple one or more audio sources (e.g., a microphone, a receiver) to processing circuitry of hearing instrument 101. The processing circuitry may cause hearing instrument 101 to output sound based at least in part on the signals from the one or more audio sources. Hearing instrument 101 may include one, two, or three or more input element(s) 110. Each of input element(s) 110 may be electrically coupled to the processing circuitry via one or more electrical conductors.

UI control(s) 108 may be configured to receive user input and transmit the received user input to the processing circuitry of hearing instrument 101. The processing circuitry may cause hearing instrument 101 to begin outputting sound, terminate outputting sound, and/or alter the outputted sound based at least in part on the received user input. Alterations to the sound may include, but are not limited to, changes in volume of the sound, changes in pitch of the sound, changes in gain of the sound, changes between input audio sources, changes in algorithms applied by the processing circuitry to generate the outputted sound, or the like. UI control(s) 108 may include one or more of buttons, dials, levers, knobs, or the like. UI control(s) 108 may be electrically coupled to the processing circuitry via one or more electrical conductors.

In some instances, the user may wear a single hearing instrument 101. In other instances, the user may wear two hearing instruments, with one hearing instrument for each car of the user. Hearing instruments for the left and right car may have a mirrored design relative to each other, for placement in the different car canals. In some examples, hearing instruments for the left and right car may each be customized to the respective ear, e.g., if the cars of the user exhibit anatomical differences in shape of the car or the car canal shape.

Hearing instrument 101 may comprise any of a wide variety of devices that are configured to provide auditory stimuli to a user and that are designed for wear and/or implantation at, on, or near an car of the user. Hearing instruments 101 may be worn, at least partially, in the ear canal or concha. Hearing instrument 101, for example, may comprise a so-called ITC hearing instrument, an ITE hearing instrument, or another hearing instrument that is designed for insertion in the car of a user while being visible by others when the hearing instrument is being worn.

In any of the examples of this disclosure, hearing instrument 101 may comprise a hearing assistance device. Hearing assistance devices include devices that help a user hear sounds in the user's environment. In some examples, hearing instrument 101 comprises an over-the-counter device, a direct-to-consumer device, or a prescription device. Furthermore, in some examples, hearing instrument 101 may further include capabilities to provide auditory stimuli to the user that correspond to artificial sounds or sounds that are not naturally in the user's environment, such as recorded music, computer-generated sounds, or other types of sounds. Some types of hearing instruments provide auditory stimuli to the user corresponding to sounds from the user's environmental and also artificial sounds. In some examples, hearing instrument 101 may provide auditory stimuli to the user via a bone conduction pathway.

FIG. 1 illustrates an example hearing instrument 101 and a manufacturing system 120. Manufacturing system 120 may perform one or more steps described herein to manufacture an example hearing instrument 101 of system 100. Manufacturing system 120 may include one or more manufacturing assemblies including, but are not limited to, additive manufacturing assemblies or subtractive manufacturing assemblies. Each manufacturing assembly may manufacture or assemble one or more components of hearing instrument 101. Manufacturing system 120 may manufacture hearing instrument 101 autonomously, e.g., via one or more robotic elements, and/or via input from one or more operators.

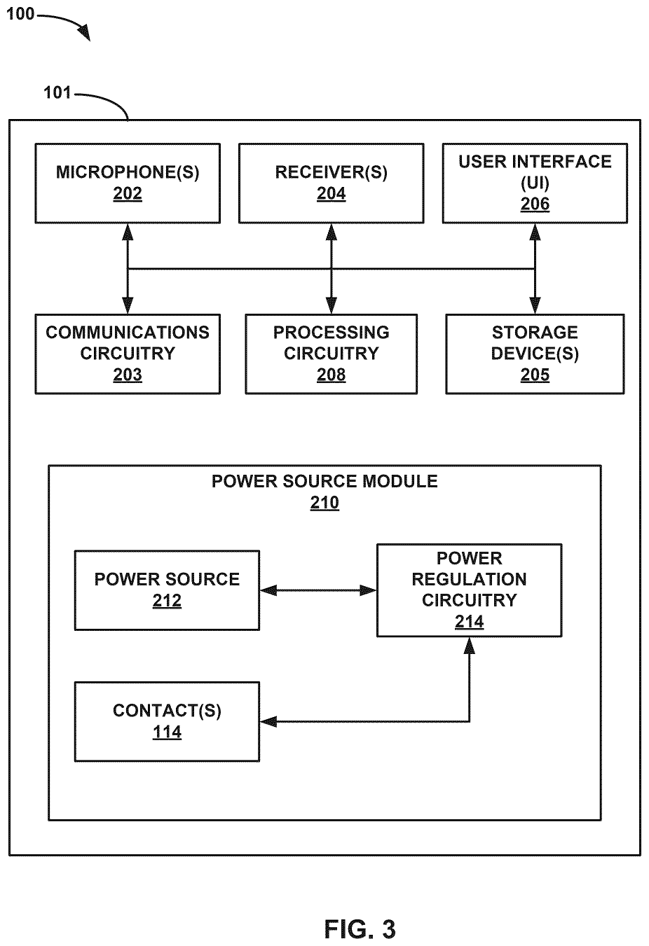

FIG. 3 is a block diagram illustrating example components of system 100 of FIG. 1. System 100 may include one or more components including, but are not limited to, microphone(s) 202, communications circuitry 203, receiver(s) 204, storage devices(s) 205, user interface (UI) 206, or processing circuitry 208. The one or more components may be disposed within an inner recess of hearing instrument 101, on faceplate 104 of hearing instrument 101, and/or may be connected to hearing instrument 101 (e.g., via input ports on faceplate 104). Power source module 210 may be removably connected to components of hearing instrument 101. Power source module 210 may include components including power source 212, power regulation circuitry 214, and one or more contact(s) 114.

Microphone(s) 202 may generate input electrical signals for system 100. Microphone(s) 202 may convert an input (e.g., sound) into an electrical signal. Microphone(s) 202 may transmit the electrical signal to processing circuitry 208 along one or more electrical conductors. Microphone(s) 202 may be integral to hearing instrument 101 (e.g., as input element(s) 110). For example, microphone(s) 202 may be disposed on and/or extend through faceplate 104. Microphone(s) 202 may include, but are not limited to, omnidirectional microphone(s), directional microphone(s), or other types of microphones. In some examples, system 100 may include one or more other audio sources in addition to or instead of microphone(s) 202, such as one or more telecoils.

Receiver(s) 204 may receive an output electrical signal (e.g., from processing circuitry 208) and convert the electrical signal into sound. Receiver(s) 204 may output the sound into the car of the user, e.g., via sound tube(s) connected to receiver(s) 204. Receiver(s) 204 may be disposed within the inner recess of hearing instrument 101 and/or disposed at or around second end 112B of hearing instrument 101. In some examples, receiver(s) 204 is disposed external to the inner recess of hearing instrument 101 and connected to processing circuitry 208 via one or more electrical conductors.

Communications circuitry 203 may enable transmission of data between system 100 and one or more other computing devices (e.g., an external computing device). Communications circuitry 203 may use various types of wireless technology to communicate. For example, communications circuitry 203 may use Bluetooth, Bluetooth LE, 3G, 4G LTE, 5G, ZigBee, WiFi, Near-Field Magnetic Induction (NFMI), or another communication technology. Communications circuitry 203 may be configured to use one or more wired communications systems to communicate with one or more other devices, such as via one or more communication cables disposed within one or more ports in hearing instrument 101 (e.g., input element(s) 110). Communication cables may include, but are not limited to, a Universal Serial Bus (USB) cable or a Lightning™ Cable.

Storage device(s) 205 may include one or more devices configured store data. The data may include, but are not limited to, computer-executable instructions, such as software instructions or firmware instructions. Storage device(s) 205 may include volatile memory and may therefore not retain stored contents if powered off. Examples of volatile memories may include random access memories (RAM), dynamic random access memories (DRAM), static random access memories (SRAM), and other forms of volatile memories known in the art. In such examples, when power source module 210 is disposed within hearing instrument 101, power source module 210 may supply electrical power (e.g., from power source 212 via power regulation circuitry 214 and one or more electrical conductors and/or contacts) to storage device(s) 205. Storage device(s) 205 may further be configured for long-term storage of information as non-volatile memory space and retain information after power on/off cycles and/or while power source module 210 is removed from hearing instrument 101. Examples of non-volatile memory configurations may include flash memories, or forms of electrically programmable memories (EPROM) or electrically erasable and programmable (EEPROM) memories.

System 100 may store data corresponding to one or more processing modes (e.g., parameters of the one or more processing modes), input audio signals, and/or output audio signals, in storage device(s) 205. Storage device(s) 205 may be disposed within hearing instrument 101. System 100 may transmit the stored information from storage device(s) 205 to an external device, a network, and/or one or more other computing devices, computing systems, and/or cloud computing environments, e.g., via a wired connection, via communications circuitry 203.

UI 206 may receive and transmit user inputs to processing circuitry 208. UI 206 may be electrically connected to processing circuitry 208 via one or more electrical conductors. UI 206 may include one or more UI controls disposed on hearing instrument 101 (e.g., UI control(s) 108). The one or more UI controls may be electrically connected to processing circuitry 208 via one or more electrical conductors. In some examples, components of UI 206 are external to hearing instrument 101 and are communicatively coupled to processing circuitry 208 via communication circuitry 203. For example, the user may interact with UI 206 on an external device (e.g., a laptop, a smartphone, a smartwatch, a tablet, an external programmer). The external device may then transmit (e.g., along a wired connection, wirelessly) the received user inputs to processing circuitry 208 (e.g., via communications circuitry 203).

Processing circuitry 208 include circuitry configured to process information. Processing circuitry 208 may convert a received input electrical signal (e.g., from microphone(s) 202, input element(s) 110) into an output electrical signal, e.g., to be converted to sound by receiver(s) 204. Processing circuitry 208 may include one or more microprocessors, digital signal processors, microcontroller units, and other types of circuitries for processing information. Processing circuitry 208 may retrieve and execute instructions from storage device(s) 205, including, software instructions firmware instructions, or another type of computer-executed instructions. Processing circuitry 208 may retrieve and execute instructions from storage device(s) 205 to convert input electrical signals to output electrical signals (e.g., for conversion by receiver(s) 204 into sound). Processing circuitry 208 may begin, terminate, or alter the conversion of electrical signals to output electrical signals in response to user input received by UI 206.

Power source module 210 may be removably disposed within hearing instrument 101. When power source module 210 is disposed within hearing instrument 101, e.g., within the inner recess of hearing instrument 101, power source module 210 may be electrically connected to one or more components of system 100 within hearing instrument 101 via electrical contact(s) and/or electrical conductor(s) and may supply electrical power to the one or more components. The one or more components may include, but are not limited to, microphone(s) 202, receiver(s) 204, components of UI 206, communications circuitry 203, processing circuitry 208, or storage device(s) 205.

Power source module 210 may include power source 212, power regulation circuitry 214, contact(s) 114, and cap 106 (not pictured in FIG. 2). A housing of power source module 210 retain power source 212 and power regulation circuitry 214. The housing and/or one or more materials disposed over and/or around the housing may isolate one or more of power source 212 and/or power regulation circuitry 214 from an external environment, e.g., to inhibit or reduce degradation or damage to power source 212 and/or power regulation circuitry 214 in response to the external environment. For example, power source module 210 may seal power source 212 and power regulation circuitry 214 against the external environment to inhibit oxidization, rusting, or other degradation. Power source module 210 may be removed from hearing instrument 101 and replaced with another power source module 210. Replacement power source module 210 may define identical dimensions and include features and components as the removed power source module 210. For example, the clinician and/or the user may replace power source module 210 with a depleted power source 212 with an otherwise identical power source module 210 with power source 212 at or around full capacity.

Power source module 210 may be replaced, e.g., if power source 212 is depleted or if one or more of power source 212 or power regulation circuitry 214 becomes damaged. To replace power source module 210, cap 106 of power source module 210 may be detached from faceplate 104 of hearing instrument 101 and power source module 210 may then be removed from within the inner recess of hearing instrument 101. The process may be reversed to insert a replacement power source module 210 into hearing instrument 101. The removal and replacement process for power source module 210 may be performed in the field (e.g., by the clinician and/or the user) and without requiring disassembly of hearing instrument 101 (e.g., separation of faceplate 104 from shell 102).

Power source 212 may be permanently affixed to power source module 210. In some examples, in order to replace power source 212 within hearing instrument 101, the entire power source module 210 is replaced. Power source 212 may include one or more devices configured to receive, store, and transmit electrical energy. The one or more devices may include batteries (e.g., rechargeable batteries) or supercapacitors. For example, power source 212 may include one or more Lithium-ion (Li-ion) batteries, zinc-air batteries, or other types of batteries. Power source 212 may comprise a generally flat and cylindrical-shaped battery that defines a cylinder with a radius and a height, wherein the radius is more than twice the length of the height. Power source 212 may be electrically coupled to power regulation circuitry 214 and contact(s) 114 via electrical conductors.

Power regulation circuitry 214 may electrically connect power source 212, contact(s) 114 and components within hearing instrument 101. Power regulation circuitry 214 may provide electrical connections between contact(s) 114 and components within hearing instruments 101 and the cathode and the anode of power source 212. For example, power regulation circuitry 214 may electrically connect contact(s) 114 to power source 212 to facilitate charging of power source 212, e.g., without removing power source 212 from power source module 210. In some examples, power regulation circuitry 214 electrically connects components of hearing instrument 101 to power source 212 to allow the components to draw electrical power from power source 212. Power regulation circuitry 214 may also include circuitry, such as one or more processors, transistors, resistors, capacitors, etc., configured to monitor and regulate power source 212. Power regulation circuitry 214 may monitor and regulate the storage capacity of power source 212, energy storage levels of power source 212, the voltage and/or amperage of energy received by power source 212 and/or transmitted by power source 212 (e.g., to components of hearing instrument 101), or the like. Power regulation circuitry 214 may monitor power source 212 by monitoring current energy storage levels of power source 212 and/or rate(s) of increase or decrease of the current energy storage levels. Power regulation circuitry 214 may transmit data corresponding to monitored information to hearing instrument 101 (e.g., to processing circuitry 208) and/or to one or more external devices (e.g., via communications circuitry 203 of hearing instrument 101). Power regulation circuitry 214 may control the voltage and/or amperage of energy received by power source 212 and/or transmitted by power source 212, e.g., to facilitate proper charging and function of power source 212 and/or to inhibit damage to components within hearing instrument 101 and/or power source module 210. Power regulation circuitry 214 may draw power from power source 212 to perform one or more of the functions discussed above.

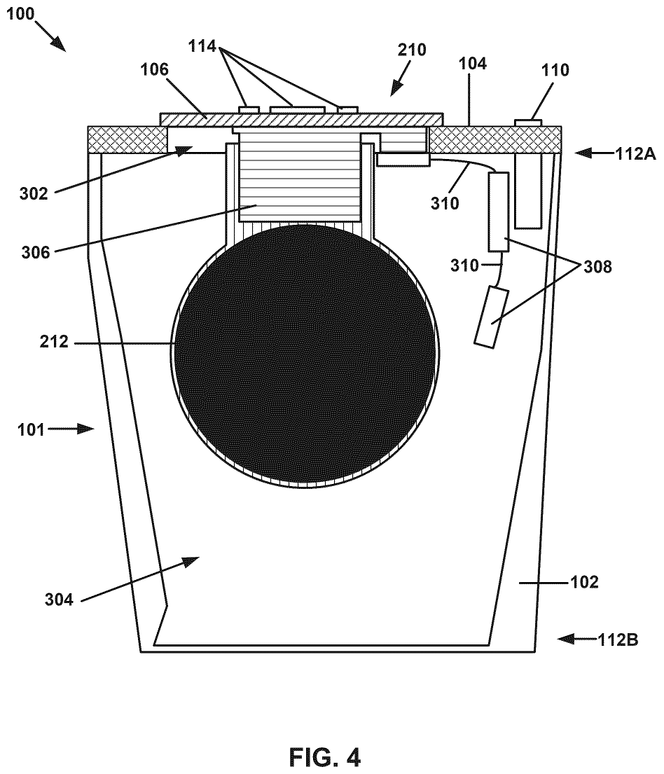

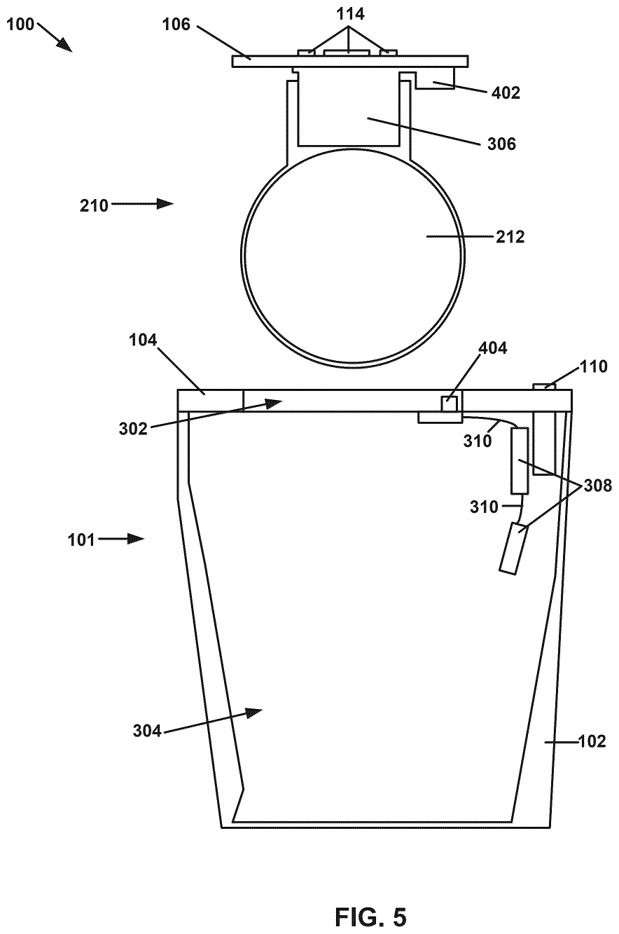

FIG. 4 is a cross-sectional diagram illustrating a cross-sectional view of the example hearing instrument 101 of FIG. 1, the cross-section being taken along line A-A of FIG. 2. FIG. 5 is a cross-sectional diagram illustrating the cross-sectional view illustrated in FIG. 4 with power source module 210 removed from hearing instrument 101. As illustrated in FIG. 4, component(s) 308 of hearing instrument 101 may be disposed within inner recess 304 of hearing instrument 101. At least a portion of power source module 210 (e.g., power source 212 and housing 306 of power source module 210) may be disposed within inner recess 304 via channel 302 in faceplate 104. Power source module 210 may be removably secured in inner recess 304 via an interface between cap 106 and faceplate 104.

Inner recess 304 may be defined by shell 102 and faceplate 104. Inner recess 304 may extend from first end 112A to second end 112B. An internal volume and/or dimensions of inner recess 304 may be dependent on the customized shape of shell 102. For example, the internal volume and/or dimensions of inner recess 304 or hearing instrument 101 customized to the user may be different from the internal volume and/or dimension of the inner recess of another hearing instrument customized to another user, e.g., due to the different shapes of the ear canals of the users.

Inner recess 304 may be accessible via channel 302 extending through faceplate 104. Channel 302 may be sized to permit entry of housing 306 and power source 212 of power source module 210 into inner recess 304 while inhibiting entry of at least a portion of cap 106 into inner recess 304. For example, a width of channel 302 along a reference axis may be greater than a width of housing 306 and/or power source 212 along the same reference axis but may be less than a width of at least a portion of cap 106 along the same reference axis.

When power source module 210 is disposed within inner recess 304, housing 306 and/or power source 212 may be physically isolated from shell 102, faceplate 104, component(s) 308, and any other components within inner recess 304. Power source module 210 may be affixed to hearing instrument 101 via an interface between cap 106 and faceplate 104. As illustrated in FIGS. 4 and 5, power source module 210 may be inserted into and/or removed from within inner recess 304 without requiring disassembly of hearing instrument 101, e.g., separation of faceplate 104 from shell 102 to allow access to inner recess 304. This may allow for simple, in-filed replacement of power source module 210 by a clinician and/or the user without requiring special tools.

Housing 306 may be configured to retain power regulation circuitry 214 (not pictured) and power source 212 within power source module 210. Housing 306 may be disposed around at least a portion of power source 212 and/or power regulation circuitry 214. In some examples, housing 306 may seal power source 212 and/or power regulation circuitry 214 against an external environment. Housing 306 may protect power source 212 and/or power regulation circuitry 214 during transit, installation, and/or removal of power source module 210. Housing 306 may be permanently affixed to cap 106. One or more feedthroughs may extend through housing 306, e.g., to connect component(s) 308 and/or contact(s) 114 to power source 212 and/or power regulation circuitry 214.

Component(s) 308 may include one or more components of hearing instrument 101 illustrated in FIG. 2, including, but are not limited to, at least portions of microphone(s) 202, receiver(s) 204, UI 206, communications circuitry 203, processing circuitry 208, and/or storage device(s) 205. Component(s) 308 may include one or more printed circuit board (PCB) assemblies. Component(s) 308 may be affixed to one or more of an inner surface of faceplate 104 or an inner surface of shell 102. Component(s) 308 may be connected via electrical conductor(s) 310. In some examples, as illustrated in FIGS. 4 and 5, component(s) 308 may be electrically connected power source module 210 (e.g., to power regulation circuitry 214 within housing 306) via electrical conductor(s) 310. Electrical conductor(s) 310 may include one or more electrically conductive wires.

As illustrated in FIG. 5, power source module 210 may include electrical contacts 402 disposed on housing 306. Electrical contacts 402 may be electrically connected to power source 212 and/or power regulation circuitry 214 via one or more electrical conductors. Hearing instrument 101 may include electrical contacts 404 disposed within channel 302 and/or inner recess 304. Electrical contacts 404 may be electrically connected to component(s) 308 via electrical conductor(s) 310. Electrical contacts 404 may affixed to one or more of faceplate 104 or shell 102. When power source module 210 is inserted into inner recess 304, as illustrated in FIG. 4, electrical contacts 402 may interface with electrical contacts 404 to electrically connect power source module 210 to components of hearing instrument 101. Components of system 100 within hearing instrument 101 (e.g., component(s) 308) may draw power from power source 212 of power source module 210 via power regulation circuitry 214, electrical conductors (e.g., conductor(s) 310), electrical contacts 402, and electrical contacts 404.

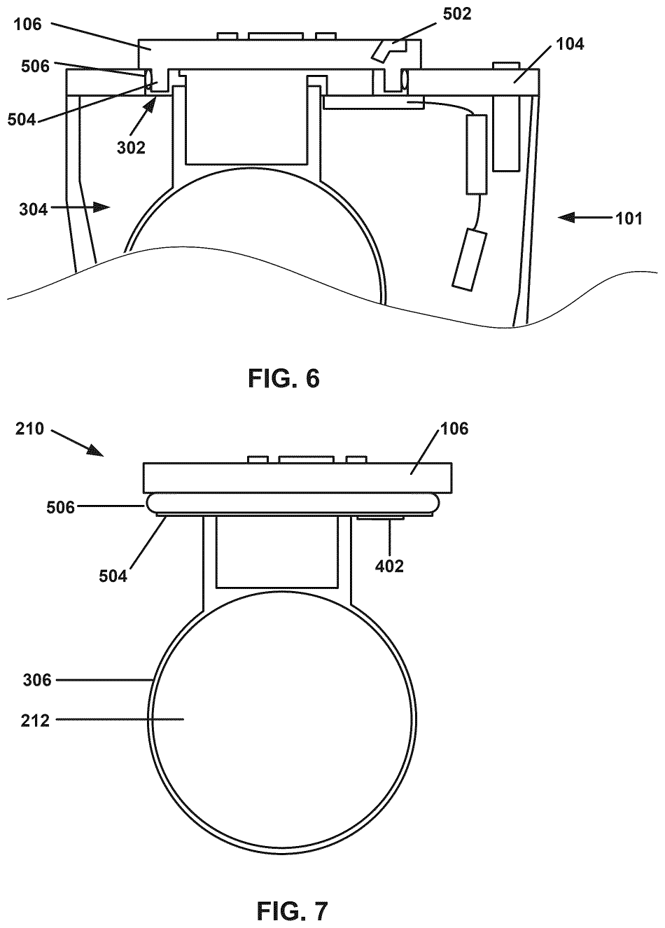

FIG. 6 is a cross-sectional diagram illustrating a cross-sectional view of the example hearing instrument of FIG. 1 with a gasket 506, the cross-section being taken along line A-A of FIG. 2. FIG. 7 is a conceptual diagram illustrating an example power source module 210 of hearing instrument 101 of FIG. 6. As illustrated in FIG. 6, cap 106 may include a protrusion 504 extending into channel 302. Gasket 506 may be disposed around an outer perimeter of protrusion 504 and interface with sidewalls of channel 302 to inhibit unintended detachment of power source module 210 from hearing instrument 101.

Protrusion 504 may extend around the perimeter of cap 106 and may define an annular or semi-annular shape along an inner surface of cap 106. Protrusion 504 may be sized to be able to be disposed within channel 302. For example, a maximum width of protrusion 504 from one end to an opposite end along a reference axis is less than the width of channel 302 along the reference axis. Gasket 506 may be disposed on the protrusion 504 and may extend around the outer perimeter of protrusion 504. In some examples, protrusion 504 defines a channel extend around the outer perimeter of protrusion 504, the channel being configured to retain the gasket 506.

Gasket 506 may be formed from a flexible, elastic material (e.g., rubber). Gasket 506 may include, but are not limited to, an O-ring or a washer. Gasket 506 may be configured to elastically deform under a compressive force. When cap 106 is disposed on faceplate 104 and protrusion 504 is inserted into channel 302, a distance between the sidewalls of faceplate 104 defining channel 302 and an outer surface of protrusion 504 may be less than or equal to a thickness of gasket 506. The reduced distance may cause gasket 506 to compress when gasket 506 is disposed within channel 302 and between protrusion 504 and sidewalls of channel 302. The compression of gasket 506 may inhibit unintended movement of power source module 210 out of inner recess 304, e.g., due to reactive forces acting on power source module 210 from gasket 506. The compression of gasket 506 may also seal the gap between protrusion 504 and the sidewalls of channel 302, thereby sealing inner recess 304 from an external environment.

Cap 106 may include one or more grooves 502 disposed on an outer surface of cap 106. A clinician and/or a user may remove power source module 210 from within inner recess 304 using groove(s) 502. The clinician and/or user may insert an object into one or more of groove(s) 502 to apply a pulling force on cap 106, thereby causing cap 106, and by extension power source module 210, to pull away from faceplate 104 and out of inner recess 304. The object may include, but are not limited to, a portion of a fingernail, a thin object capable of entering groove(s) 502 (e.g., edge of a coin, of a plastic card, end of a paper clip, or the like). The clinician and/or the user may interact with groove(s) 502 and apply a pulling force on cap 106 without requiring use of a specialized tool or implement.

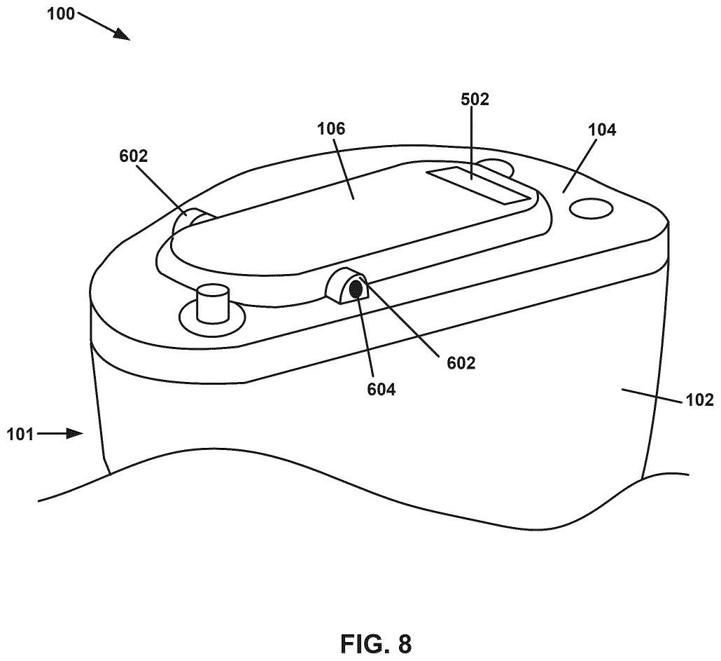

FIG. 8 is a conceptual diagram illustrating an example of the hearing instrument of FIG. 1 with a cross pin 604. As illustrated in FIG. 8, cross pin 604 may be inserted through openings defined through protrusions 602 of faceplate 104 and a channel defined through cap 106 to affix cap 106 to faceplate 104.

Protrusions 602 may extend from an outer surface of faceplate 104. Each of protrusions 602 may define an opening sized to receive cross pin 604. For example, a diameter of the opening within protrusion 602 may be greater than or equal to an outer diameter of cross pin 604. Openings within different protrusions 602 may be aligned, e.g., to allow insertion of a single cross pin 604 through the openings within the different protrusions 602.

Cap 106 may define a channel extending through cap 106. The channel may extend across the width of cap 106. The channel may be sized to receive cross pin 604. For example, the diameter of the channel may be greater than or equal to an outer diameter of cross pin 604. Openings within protrusions 602 may be aligned with the channel within cap 106, e.g., to allow insertion of a single cross pin 604 through the openings and the channel.

Cross pin 604 may define an elongated body. The elongated body may define a length greater than or equal to a width of a length of cap 106. Cross pin 604 may be inserted through openings of protrusions 602 and the channel within cap 106 and be disposed within protrusions 602 and cap 106. When cross pin 604 is disposed within protrusions 602 and cap 106, cross pin 604 may secure cap 106 to protrusions 602, thereby affixing power source module 210 to hearing instrument 101. System 100 may include one or more fixation features, such as one or more of cross pin 604, gasket 506, or groove(s) 502. In other examples, system 100 may include one or more other fixation features disposed on faceplate 104 and/or cap 106, such as, but is not limited to, snap-fit features, a pin (e.g., a spring-loaded pin), screw(s), or locking lugs and recesses.

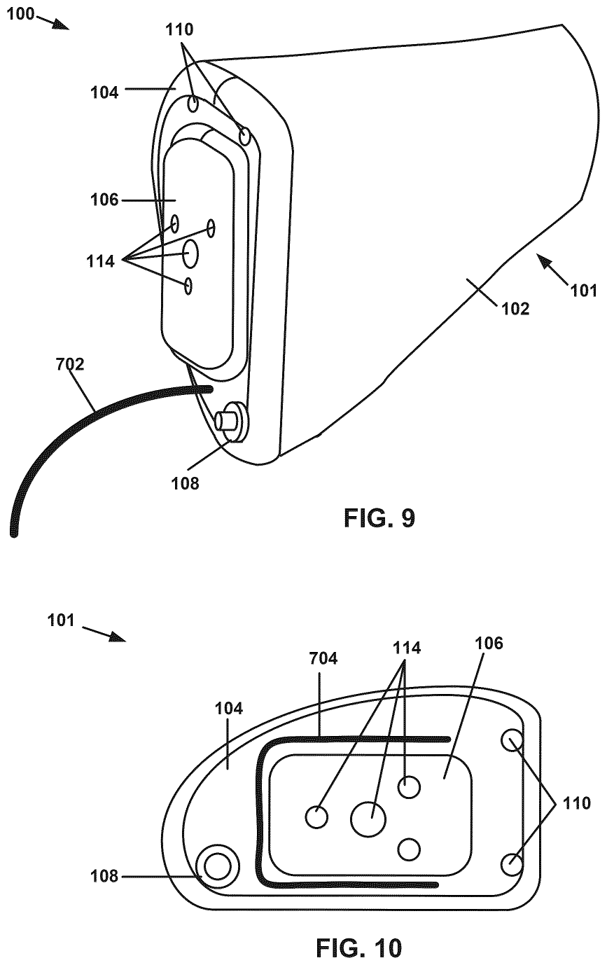

FIG. 9 is a conceptual diagram illustrating an example of hearing instrument 101 of FIG. 1 with an antenna 702. FIG. 10 is a conceptual diagram illustrating a front view of an example of hearing instrument 101 of FIG. 1 with another example antenna 704. Hearing instrument 101 may include one or more antennas (e.g., antenna 702, antenna 704) extending external to inner recess 304. The one or more antennas may facilitate wireless communication between hearing instrument 101 and one or more external devices. The one or more antennas may be embedded within faceplate 104 and/or may extend from inner recess 304 and through faceplate 104.

The one or more antennas may include antenna 702 or antenna 704. Antenna 702 may extend away from faceplate 104. Antenna 704 may be secured to the outer surface of faceplate 104. Antenna 704 may be disposed around cap 106, e.g., to reduce interference between antenna 704 and cap 106. The one or more antennas may be retracted into and/or advance from within inner recess 304. In other examples, the one or more antennas may be entirely disposed within inner recess 304.

FIGS. 1-10 illustrate various hearing instruments and power assemblies described in this disclosure. In some examples, this disclosure describes a hearing instrument 101 configured to be worn in, on, or about an ear of a user, the hearing instrument 101 comprising: a shell 102 defining an inner recess 304; processing circuitry 208 disposed within inner recess 304, processing circuitry 208 being configured to cause hearing instrument 101 to output sound; a faceplate 104 coupled to shell 102, faceplate 104 being configured to enclose inner recess 304 from an external environment; and a removable power source module 210 configured to be disposed within inner recess 304, removable power source module 210 comprising a power source 212, wherein removable power source module 210 is removably affixed to faceplate 104.

In some examples, power source module 210 comprises: a power source 212; electrical contacts 402 electrically coupled to power source 212; and a cap 106 connected to power source 212, wherein power source module 210 is configured to be disposed within a hearing instrument 101 configured to be worn in, on, or about an car of a user; and wherein power source module 210 is configured to be removed from within hearing instrument 101 without requiring disassembly of hearing instrument 101.

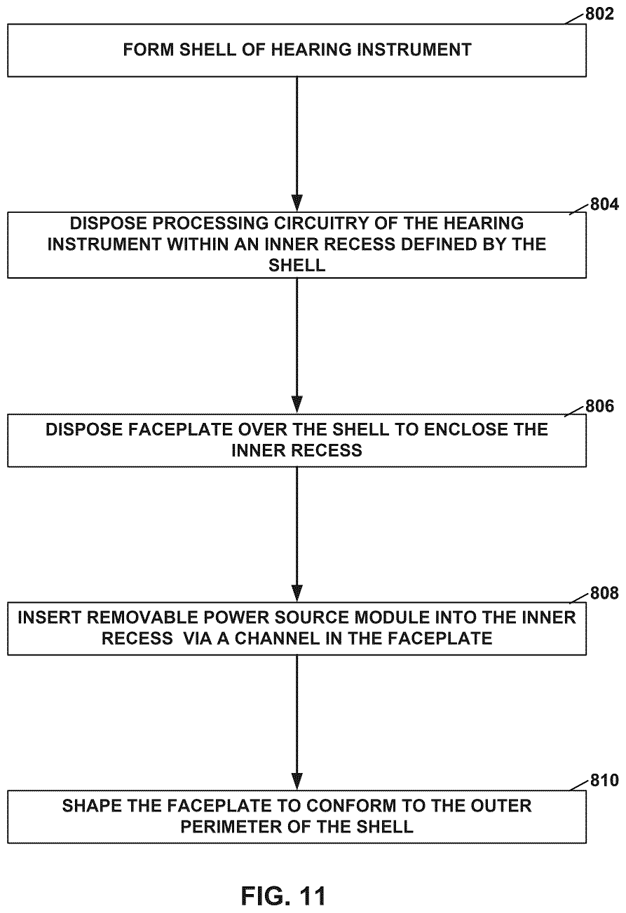

FIG. 11 is a flow chart illustrating an example process of manufacturing an example hearing instrument 101. The example process illustrated in FIG. 11 may be performed by manufacturing system 120. Manufacturing system 120 may include subtractive manufacturing assemblies and/or additive manufacturing assemblies and one or more components of hearing instrument 101 may be formed via subtractive or additive manufacturing. Manufacturing system 120 may include assemblies which may perform one or more of the steps illustrated in FIG. 11 autonomously, e.g., via one or more robotic elements. For example, manufacturing system 120 may autonomously perform the steps of FIG. 11 to manufacture an example hearing instrument 101. Manufacturing system 120 may include assemblies which may be control by an operator to perform one or more steps illustrated in FIG. 11. While the example process illustrated in FIG. 11 is primarily described herein with respect to hearing instrument 101 as illustrated in FIGS. 1-10, the example process may be performed to manufacture any example hearing instruments described in this disclosure.

Manufacturing system 120 may form shell 102 of hearing instrument 101 (802). Shell 102 may be customized to a shape of an ear canal of the user, e.g., to improve user comfort and/or improve retention of hearing instrument 101 within an car of the user. In other examples, shell 102 is not specific to the shape of the ear canal of a specific user. Manufacturing system 120 may receive data corresponding to a scan or a mold of the car canal of the user. Based on the received data, manufacturing system 120 may form shell 102 to contour to the shape of the car canal of the user, e.g., via injection molding, cutting and buffing, or three-dimensional (3D) printing. When formed, shell 102 may only fit inside the car of the user in a specific orientation.

Manufacturing system 120 may dispose processing circuitry 208 of hearing instrument 101 within inner recess 304 defined by shell 102 (804). Manufacturing system 120 may insert components 308 into inner recess 304, including processing circuitry 208 into inner recess 304, e.g., via an opening at first end 112A. Manufacturing system 120 may affix components 308 to an inner surface of shell 102. For example, manufacturing system 120 may affix one or more receiver(s) 204 of components 308 to the inner surface of shell 102 at or around second end 112B of hearing instrument 101.

Manufacturing system 120 may dispose faceplate 104 over shell 102 to enclose inner recess 304 (806). Manufacturing system 120 may orient an inner surface of faceplate 104 towards the opening defined by shell 102 at first end 112A and may place the inner surface of faceplate 104 over the opening of shell 102 to enclose inner recess 304. Faceplate 104 may be uncut, e.g., may define an outer perimeter that does not correspond to the shape of shell 102. In such examples, faceplate 104 may define a greater width and/or height than an opening of shell 102 at first end 112A.

External features disposed on or through faceplate 104 (e.g., UI control(s) 108, input element(s) 110, fixation features (e.g., protrusions 602), antenna 702, or antenna 704) may be pre-attached to faceplate 104. In some examples, manufacturing system 120 attaches the components to faceplate 104 prior to disposing faceplate 104 over opening of shell 102. Channel 302 may be pre-formed on faceplate 104 or may be formed by manufacturing system 120. Manufacturing system 120 may electrically couple the components disposed on or through faceplate 104 with components 308 via electrical conductor(s) 310. Manufacturing system 120 may re-adjust the position and/or orientation of faceplate 104 over shell 102 until manufacturing system 120 determines that the electrical connections between components 308 and components disposed on or through faceplate 104 are established without physical and/or electrical interference.

Manufacturing system 120 may insert power source module 210 into shell 102 through channel 302 in faceplate 104 (808). Power source module 210 may be standardized, e.g., the shape of power source module 210 may be independent of the shape of shell 102 and/or the inner volume of inner recess 304 defined by shell 102. Manufacturing system 120 may establish electrical connections between power source module 210 and components 308, e.g., via contacts 402, 404, and conductor(s) 310. Manufacturing system 120 may determine whether power source module 210 may be inserted into inner recess 304 without interference from any of the components (e.g., components 308) or electrical connections (e.g., electrical conductor(s) 310) disposed within inner recess 304. Manufacturing system 120 may also determine whether power source module 210 may be inserted into inner recess 304 without interference from the inner surface of shell 102.

Manufacturing system 120 may determine orientations for power source module 210 and processing circuitry 208 within inner recess 304. A longitudinal axis of hearing instrument 101 may extend from first end 112A to second end 112B. The orientation for each of power source module 210 and processing circuitry 208 may be defined relative to a major axis and a minor axis of hearing instrument 101 along a reference plane orthogonal to the longitudinal axis of hearing instrument 101. The orientations for power source module 210 and processing circuitry 208 may define the positioning of power source module 210 and processing circuitry 208 within inner recess 304 and whether power source module 210 interferes with processing circuitry 208 or any other of components 308 as power source module 210 is inserted or removed from within inner recess 304. For example, when power source module 210 is at a specific orientation within inner recess 304, power source module 210 may be removed from within inner recess 304 without interference from components 308 (e.g., from processing circuitry 208), shell 102, and faceplate 104.

Manufacturing system 120 may re-position faceplate 104 and/or power source module 210 relative to shell 102 until manufacturing system 120 determines that faceplate 104 is disposed over shell 102 at a specific position. The position and orientation of faceplate 104 (e.g., the position and orientation of channel 302 within faceplate 104) relative to shell 102 may determine the position and orientation of power source module 210. When faceplate 104 is at the specific position, power source module 210 may be correspondingly disposed at the specific position and/or specific orientation where there is no interference between power source module 210 and components 308 (e.g., processing circuitry 208), shell 102, or faceplate 104 during insertion and removal of power source module 210 from within inner recess 304. Manufacturing system 120 may also determine whether power source module 210 may be secured to faceplate 104 (e.g., whether cap 106 of power source module 210 may be secured to faceplate 104) without interference from components within inner recess 304.

Manufacturing system 120 may shape faceplate 104 to conform to the outer perimeter of shell 102 (810). Once manufacturing system 120 determines the proper position and orientation for faceplate 104 and power source module 210 and determines that all electrical connections between components 308, faceplate 104, and power source module 210 are established, manufacturing system 120 may affix faceplate 104 to shell 102, e.g., to fully enclose inner recess 304. Manufacturing system 120 may affix faceplate 104 to shell 102 via an adhesive, a mechanical fixation feature (e.g., one or more screws, one or more pins), a friction fit, or the like.

In some examples, once faceplate 104 is affixed to shell 102, manufacturing system 120 shapes faceplate 104 to conform to (e.g., to be flush with) an outer perimeter of shell 102 at first end 112A. Manufacturing system 120 may use a subtractive manufacturing process (e.g., a cutting instrument, a laser-cutting technique, a sanding technique) to remove material from the outer edges of faceplate 104 until faceplate 104 conforms to the outer perimeter of shell 102 at first end 112A. In some examples, manufacturing system 120 shapes faceplate 104 prior to fixation of faceplate 104 to shell 102. Manufacturing system 120 may shape faceplate 104 while power source module 210 is removed from within hearing instrument 101.

In some examples, this disclosure describes a method of manufacturing a hearing instrument 101 configured to be worn in, on, or about an car of a user, the method comprising: forming, by a manufacturing system, a shell 102 of hearing instrument 101, wherein shell 102 is configured to conform to a shape of an car canal of the user; disposing, by manufacturing system 120, processing circuitry 208 of hearing instrument 101 within an inner recess 304 defined by shell 102; affixing, by manufacturing system 120, a faceplate 104 to shell 102 to enclose inner recess 304; disposing, by manufacturing system 120, a removable power source module 210 within inner recess 304 of hearing instrument 101 via a channel 302 in faceplate 104, wherein removable power source module 210 comprises: a power source 212, and a cap 106; and removably affixing, by manufacturing system 120, cap 106 to faceplate 104.

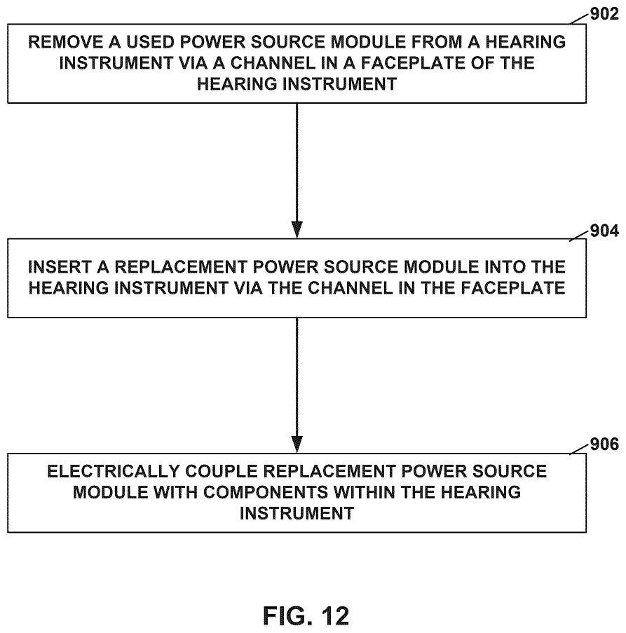

FIG. 12 is a flow chart illustrating an example process of replacing an example removable power source module 210 within an example hearing instrument 101. While the example process of FIG. 12 is primarily described below with reference to example hearing instrument 101 and power source module 210 as illustrated in FIGS. 1-10, the example process may be applied to replace a power source module within any of the example hearing instruments described herein. Additionally, while the example process is primarily described below as being performed by a user, the process may be performed by any other parties including, but are not limited to, a clinician, a manufacturer, or a manufacturing system.

A user may remove a used power source module 210 from hearing instrument 101 via a channel 302 in faceplate 104 of hearing instrument 101 (902). The user may interface with one or more fixation elements on faceplate 104 and/or cap 106 to de-couple cap 106 from faceplate 104. The one or more fixation elements may include, but are not limited to, gasket 506, cross pin 604, snap-fit feature(s), screw(s), pin(s), locking lug(s), spring(s), or the like. For example, the user may apply a pulling force on cap 106 away from faceplate 104 (e.g., via groove(s) 502). In some examples, the user may remove cross pin 604 extending through faceplate 104 (e.g., protrusions 602 of faceplate 104) and cap 106 (e.g., a channel within cap 106). Once cap 106 is de-coupled from faceplate 104, the user may apply a pulling force on cap 106 away from and relative to faceplate 104 to remove the used power source module 210 from hearing instrument 101. The used power source module 210 may travel through channel 302 in faceplate 104 to exit hearing instrument 101 (e.g., to exit inner recess 304 of hearing instrument 101. As the user removes the used power source module 210 from within hearing instrument 101, contacts 402 of the used power source module 210 may automatically separate from contacts 404, thereby electrically separating power source module 210 from components 308. The user may recharge the used power source module 210 via contact(s) 114 disposed on cap 106 of the used power source module 210.

The user may insert a replacement power source module 210 into hearing instrument 101 via channel 302 (904). The user may electrically couple the replacement power source module 210 with components 308 within hearing instrument 101 (906). The user may insert the replace power source module 210 into inner recess 304 hearing instrument 101 through channel 302 until cap 106 of power source module 210 interfaces with faceplate 104. Contacts 402 of the replacement power source module 210 may interface with contacts 404 and establish an electrical connection between contacts 402, 404 as the replacement power source module 210 is inserted into inner recess 304 of hearing instrument 101. In other examples, the user may manually electrically couple contacts 402 to contacts 404. For example, after insertion of the replacement power source module 210 into hearing instrument 101, the user may rotate power source module 210 within inner recess 304 to electrically couple contacts 402 and contacts 404. The user may perform a single action to secure power source module 210 to hearing instrument 101 and to electrically couple contacts 402 to contacts 404. Example actions may include, but are not limited to, rotation of power source module 210 within hearing instrument 101, insertion of power source module 210 into hearing instrument 101 by at least a threshold distance, or insertion of a fixation feature (e.g., cross pin 604) through hearing instrument 101 and power source module 210. Components 308 may draw electrical power from power source 212 within power source module 210 via the electrical connection between contacts 402, 404.

The following example may demonstrate one or more aspects of the disclosure.
Example 1: a hearing instrument configured to be worn in, on, or about an car of a user, the hearing instrument comprising: a shell defining an inner recess; processing circuitry disposed within the inner recess, the processing circuitry being configured to cause the hearing instrument to output sound; a faceplate coupled to the shell, the faceplate being configured to enclose the inner recess from an external environment; and a removable power source module configured to be disposed within the inner recess, the removable power source module comprising a power source, wherein the removable power source module is removably affixed to the faceplate.
Example 2: the hearing instrument of example 1, wherein the hearing instrument comprises a first electrical contact disposed within the shell, wherein the first electrical contact is electrically coupled to the processing circuitry, wherein the removable power source module comprises a second electrical contact electrically coupled to the power source, and wherein when the removable power source module is disposed within the inner recess, the first electrical contact is electrically coupled to the second electrical contact to supply electrical energy to the processing circuitry.
Example 3: the hearing instrument of any of examples 1 and 2, wherein the removable power source module is configured to be removed from within the inner recess without separating the shell and the faceplate.
Example 4: the hearing instrument of any of examples 1-3, wherein the removable power source module comprises a cap, wherein the cap is connected to the power source, and wherein the cap is configured to be removably affixed with the faceplate to secure the removable power source module to the faceplate.
Example 5: the hearing instrument of example 4, wherein the cap is removably affixed to the faceplate via a fixation feature disposed on one or more of the cap or the faceplate, the fixation feature comprising one or more of a gasket or a cross pin.
Example 6: the hearing instrument of any of examples 4 and 5, wherein when the cap interfaces with the faceplate, the cap seals the inner recess from the external environment.
Example 7: the hearing instrument of any of examples 4-6, wherein when the cap is removably affixed to the faceplate, the power source is entirely disposed within the inner recess.
Example 8: the hearing instrument of any of examples 1-6, wherein the shell is custom molded to the ear canal of the ear of the user.
Example 9: the hearing instrument of any of examples 1-8, wherein the removable power source module is configured to isolate the power source from the external environment.
Example 10: the hearing instrument of any of examples 1-9, wherein the removable power source module further comprises power regulation circuitry, wherein the power regulation circuitry regulates a power level of the power source, and wherein when the removable power source module is disposed within the inner recess, the power regulation circuitry is electrically coupled to the processing circuitry.
Example 11: the hearing instrument of any of examples 1-10, further comprising one or more input ports disposed on the faceplate, wherein each input port of the one or more input ports is configured to electrically couple an input device to the processing circuitry, and wherein the processing circuitry is configured to output the sound based at least in part on an electrical signal from the input device.
Example 12: the hearing instrument of example 11, wherein the input device comprises one or more of a microphone or a receiver.
Example 13: the hearing instrument of any of examples 1-12, further comprising a user interface (UI) control disposed on the faceplate, wherein the UI control is electrically coupled to the processing circuitry via an electrical conductor.
Example 14: the hearing instrument of any of examples 1-13, further comprising: communications circuitry disposed within the inner recess and an antenna extending from within inner recess and through the faceplate, wherein the communications circuitry is electrically coupled to the processing circuitry via an electrical conductor and is configured to: receive electrical signals; and transmit the received electrical signals to the processing circuitry, and wherein the communications circuitry is electrically coupled to the antenna.
Example 15: the hearing instrument of any of examples 1-14, wherein the removable power source module is rechargeable.
Example 16: a power source module comprising: a power source; a plurality of electrical contacts electrically coupled to the power source; and a cap connected to the power source, wherein the power source module is configured to be disposed within a hearing instrument configured to be worn in, on, or about an ear of a user; and wherein the power source module is configured to be removed from within the hearing instrument without requiring disassembly of the hearing instrument.
Example 17: the power source module of example 16, wherein the power source and the plurality of electrical contacts are sized to be disposed within an inner recess of the hearing instrument, the inner recess being based on a shape of an ear canal of a user.
Example 18: the power source module of any of examples 16 and 17, wherein when the power source module is disposed within the hearing instrument, the plurality of electrical contacts electrically couples the power source to processing circuitry of the hearing instrument.
Example 19: the power source module of any of examples 16-18, wherein the power source module is configured to be rechargeable.
Example 20: the power source module of any of examples 16-19, wherein the cap of the power source module is configured to be removably affixed to a faceplate of the hearing instrument, and wherein when the cap is affixed to the faceplate, the power source and the plurality of electrical contacts are disposed within the hearing instrument.
Example 21: the power source module of example 20, wherein the cap is affixed to the faceplate via a fixation feature disposed on one or more of the cap or the faceplate.
Example 22: the power source module of example 21, wherein the fixation feature comprises one of more of: a gasket; or a cross pin.
Example 23: the power source module of any of examples 20-22, wherein when the cap is affixed to the faceplate, the cap seals an inner volume of the hearing instrument from an external environment.
Example 24: the power source module of any of examples 16-23, further comprising a housing connected to the cap, wherein the power source is disposed within the housing, and wherein the housing isolates the power source from an external environment.
Example 25: the power source module of any of examples 16-24, further comprising power regulation circuitry electrically coupled to the power source, wherein the power regulation circuitry is configured to regulate a power level of the power source.
Example 26: the power source module of example 25, wherein when the power source module is disposed within the hearing instrument, the power regulation circuitry is configured to be electrically coupled to processing circuitry of the hearing instrument.
Example 27: the power source module of any of examples 16-26, wherein the plurality of electrical contacts comprises a first plurality of electrical contacts, and wherein the power source module further comprises a second plurality of electrical contacts disposed on the cap, wherein is the second plurality of electrical contacts are electrically coupled to the power source, and wherein second plurality of electrical contacts are configured to transfer electrical energy between the power source and an external power source.
Example 28: a method of manufacturing a hearing instrument configured to be worn in, on, or about an car of a user, the method comprising: forming, by a manufacturing system, a shell of the hearing instrument, wherein the shell is configured to conform to a shape of an car canal of the user; disposing, by the manufacturing system, processing circuitry of the hearing instrument within an inner recess defined by the shell; disposing, by the manufacturing system, a faceplate over the shell to enclose the inner recess; and inserting, by the manufacturing system, a removable power source module into the inner recess of the hearing instrument via a channel in the faceplate, wherein the removable power source module comprises a power source and a cap.
Example 29: the method of example 28, wherein disposing the faceplate over the shell comprises: positioning, by the manufacturing system, the faceplate over an opening to the inner recess defined by the shell; inserting, by the manufacturing system, the removable power source module into the inner recess via the channel; determining, by the manufacturing system, orientation for the processing circuitry and the removable power source module within the inner recess, wherein when the removable power source module is in a specific orientation, the removable power source module is configured to be removed from within the inner recess without interference from the shell, the faceplate, or the processing circuitry; adjusting, by the manufacturing system, the position of the faceplate over the shell to a specific position, wherein when the faceplate is in the specific position, the removable power source module is disposed in the specific orientation within the inner recess; and affixing, by the manufacturing system, the faceplate to the shell when the faceplate is in the specific position.
Example 30: the method of example 29, wherein affixing the faceplate to the shell comprises inserting a cross pin through the cap and the faceplate.
Example 31: the method of any of examples 29 and 30, wherein affixing the faceplate to the shell comprises placing a gasket disposed on the cap in contact with sidewalls of the faceplate defining the channel.
Example 32: the method of any of examples 29-31, wherein affixing the faceplate to the shell comprises: disposing the faceplate over an opening to the inner recess defined by the shell; electrically coupling one or more external features on the faceplate to the processing circuitry within the inner recess via one or more electrical conductors; and affixing the faceplate to the shell.
Example 33: the method of example 32, wherein the one or more external features comprises one or more of: an input port; or a user interface (UI) control.
Example 34: the method of any of examples 28-33, further comprising shaping the faceplate to conform to an outer perimeter of the shell.
Example 35: the method of any of examples 28-34, wherein the shell defines a customized shape corresponding to an car canal of the user.
Example 36: the method of example 35, further comprising electrically coupling a first electrical contact within the inner recess of the hearing instrument to a second electrical contact on the removable power source module.
Example 37: the method of any of examples 28-36, wherein when the removable power source module is inserted into the inner recess, the cap seals the inner recess from an external environment.

In this disclosure, ordinal terms such as “first,” “second,” “third,” and so on, are not necessarily indicators of positions within an order, but rather may be used to distinguish different instances of the same thing. Examples provided in this disclosure may be used together, separately, or in various combinations. Furthermore, with respect to examples that involve personal data regarding a user, it may be required that such personal data only be used with the permission of the user.

It is to be recognized that depending on the example, certain acts or events of any of the features or techniques described herein can be created, assembled, or performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

Various examples have been described. These and other examples are within the scope of the following claims.

What is claimed is:

1. A hearing instrument configured to be worn in, on, or about an ear of a user, the hearing instrument comprising:
a receiver;
a shell defining an inner recess;
processing circuitry disposed within the inner recess, the processing circuitry being configured to cause the receiver of the hearing instrument to output sound;
a faceplate coupled to the shell, the faceplate being configured to enclose the inner recess from an external environment; and
a removable power source module configured to be disposed within the inner recess, the removable power source module comprising a power source, wherein the removable power source module is removably affixed to the faceplate.

2. The hearing instrument of claim 1,
wherein the hearing instrument comprises a first electrical contact disposed within the shell, wherein the first electrical contact is electrically coupled to the processing circuitry,
wherein the removable power source module comprises a second electrical contact electrically coupled to the power source, and
wherein when the removable power source module is disposed within the inner recess, the first electrical contact is electrically coupled to the second electrical contact to supply electrical energy to the processing circuitry.

3. The hearing instrument of claim 1, wherein the removable power source module is configured to be removed from within the inner recess without separating the shell and the faceplate.

4. The hearing instrument of claim 1, wherein the removable power source module comprises a cap, wherein the cap is connected to the power source, and wherein the cap is configured to be removably affixed with the faceplate to secure the removable power source module to the faceplate.

5. The hearing instrument of claim 4, wherein the cap is removably affixed to the faceplate via a fixation feature disposed on one or more of the cap or the faceplate, the fixation feature comprising one or more of a gasket or a cross pin.

6. The hearing instrument of claim 4, wherein when the cap interfaces with the faceplate, the cap seals the inner recess from the external environment.

7. The hearing instrument of claim 4, wherein when the cap is removably affixed to the faceplate, the power source is entirely disposed within the inner recess.

8. The hearing instrument of claim 1, wherein the shell is custom molded to the ear canal of the ear of the user.

9. The hearing instrument of claim 1, wherein the removable power source module further comprises power regulation circuitry, wherein the power regulation circuitry regulates a power level of the power source, and wherein when the removable power source module is disposed within the inner recess, the power regulation circuitry is electrically coupled to the processing circuitry.

10. The hearing instrument of claim 1, further comprising one or more input ports disposed on the faceplate, wherein each input port of the one or more input ports is configured to electrically couple an input device to the processing circuitry, and wherein the processing circuitry is configured to output the sound based at least in part on an electrical signal from the input device.

11. The hearing instrument of claim 1, further comprising a user interface (UI) control disposed on the faceplate, wherein the UI control is electrically coupled to the processing circuitry via an electrical conductor.

12. A power source module comprising:
a power source;
a plurality of electrical contacts electrically coupled to the power source; and
a cap connected to the power source,
wherein the power source module is configured to be disposed within a hearing instrument configured to be worn in, on, or about an ear of a user; and
wherein the power source module is configured to be removed from within the hearing instrument without requiring disassembly of the hearing instrument.

13. The power source module of claim 12,
wherein the power source and the plurality of electrical contacts are sized to be disposed within an inner recess of the hearing instrument, the inner recess being based on a shape of an ear canal of the ear of the user.

14. The power source module of claim 12, wherein when the power source module is disposed within the hearing instrument, the plurality of electrical contacts electrically couples the power source to processing circuitry of the hearing instrument.

15. The power source module of claim 12, wherein the cap is configured to be removably affixed to a faceplate of the hearing instrument, and wherein when the cap is affixed to the faceplate, the power source and the plurality of electrical contacts are disposed within the hearing instrument.

16. The power source module of claim 15, wherein the cap is affixed to the faceplate via a fixation feature disposed on one or more of the cap or the faceplate.

17. The power source module of claim 16, wherein the fixation feature comprises one of more of:
a gasket; or
a cross pin.

18. A method of manufacturing a hearing instrument configured to be worn in, on, or about an ear of a user, the method comprising:
forming, by a manufacturing system, a shell of the hearing instrument, wherein the shell is configured to conform to a shape of an ear canal of the user;
disposing, by the manufacturing system, processing circuitry of the hearing instrument within an inner recess defined by the shell;
disposing, by the manufacturing system, a faceplate over the shell to enclose the inner recess; and
inserting, by the manufacturing system, a removable power source module into the inner recess of the hearing instrument via a channel in the faceplate, wherein the removable power source module comprises a power source and a cap.

19. The method of claim 18, wherein disposing the faceplate over the shell comprises:
positioning, by the manufacturing system, the faceplate over an opening to the inner recess defined by the shell;
inserting, by the manufacturing system, the removable power source module into the inner recess via the channel;
determining, by the manufacturing system, orientation for the processing circuitry and the removable power source module within the inner recess, wherein when the removable power source module is in a specific orientation, the removable power source module is configured to be removed from within the inner recess without interference from the shell, the faceplate, or the processing circuitry;
adjusting, by the manufacturing system, the position of the faceplate over the shell to a specific position, wherein when the faceplate is in the specific position, the removable power source module is disposed in the specific orientation within the inner recess; and
affixing, by the manufacturing system, the faceplate to the shell when the faceplate is in the specific position.

20. The method of claim 19, wherein affixing the faceplate to the shell comprises:
disposing the faceplate over the opening to the inner recess defined by the shell;
electrically coupling one or more external features on the faceplate to the processing circuitry within the inner recess via one or more electrical conductors; and
affixing the faceplate to the shell.
